(19) United States
(12) Patent Application Publication
(10) Pub. No.: US 2006/0173556 A1
(43) Pub. Date: Aug. 3, 2006

(54) Methods and apparatus for using user gender and/or age group to improve the organization of documents retrieved in response to a search query

(75) Inventor: Louis B. Rosenberg, Pismo Beach, CA (US)

Correspondence Address: SINSHEIMER, SCHIEBELHUT, BAGGETT, 1010 PEACH STREET, SAN LUIS OBISPO, CA, 93401, US

(73) Assignee: Outland Research,. LLC, Pismo Beach, CA (US)

(21) Appl. No.: 11/341,021

(22) Filed: Jan. 27, 2006

Related U.S. Application Data
(63) Continuation-in-part of application No. 11/298,797, filed on Dec. 9, 2005.
(60) Provisional application No. 60/649,240, filed on Feb. 1, 2005.
(60) Provisional application No. 60/754,387, filed on Dec. 27, 2005.

(51) Int. Cl. G06F 17/30; G05B 19/18

(52) U.S. Cl. 700/3

(57) ABSTRACT

A computer implemented method of organizing a set of documents, and associated apparatus, are adapted to receive a search query from a user; obtain identified-age and/or -gender data for the user; identify a set of documents responsive to the search query; assign a score to each identified document based upon a correlation between age- and/or gender-usage data for each document and identified-age and/or -gender data, respectively; and organize the documents based at least in part on the assigned score. The identified-age data describes an age of the user and the identified-gender data describes a gender of the user. The age-usage data describes a number and/or frequency of users who previously accessed the document who are of a particular age or age range. The gender-usage data describes a number and/or frequency of users who previously accessed the document who are of a particular gender.

This application is a continuation-in-part of U.S. application Ser. No. 11/298,797, filed Dec. 9, 2005, which is incorporated in its entirety herein by reference, and which claims the benefit of U.S. Provisional Application No. 60/649,240, filed Feb. 1, 2005.

This application also claims the benefit of U.S. Provisional Application No. 60/754,387 filed Dec. 27, 2005, which is incorporated in its entirety herein by reference.

This application also relates to U.S. application Ser. No. 11/282,379, filed Nov. 18, 2005, which is incorporated in its entirety herein by reference, and which claims the benefit of U.S. Provisional Application No. 60/653,975, filed Feb. 16, 2005.

### BACKGROUND

1. Field of Invention

Embodiments disclosed herein generally relate to internet search engines and, more particularly, to employing data related to user age and/or user gender to improve information search, retrieval, and organization, during internet searching.

2. Discussion of the Related Art

The World Wide Web (“web”) contains a vast amount of information. Locating a desired portion of the information, however, can be challenging. This problem is compounded because the amount of information on the web and the number of new users who are inexperienced at web research is growing rapidly.

People generally surf the web based on its link graph structure, often starting with high quality human-maintained indices or use search engines such as Google or Yahoo. Human-maintained lists cover popular topics effectively but are subjective, expensive to build and maintain, slow to improve, and do not cover all esoteric topics.

Automated search engines, in contrast, locate web sites by matching search terms entered by the user to an indexed corpus of web pages. Generally, the search engine returns a list of web sites sorted based on relevance to the user's search terms. Determining the correct relevance, or importance, of a web page to a user, however, can be a difficult task. For one thing, the importance of a web page to the user is inherently subjective and depends on the user's interests, knowledge, and attitudes. There is, however, much that can be determined objectively about the relative importance of a web page.

Conventional methods of determining relevance are based on matching a user's search terms to terms indexed from web pages. More advanced techniques determine the importance of a web page based on more than the content of the web page. For example, one known method, described in the article entitled “The Anatomy of a Large-Scale Hypertextual Search Engine,” by Sergey Brin and Lawrence Page, assigns a degree of importance to a web page based on the link structure of the web page. Another known method is disclosed in U.S. Patent Application Publication No. 2002/0123988, as published on Sep. 5, 2002, and is hereby incorporated by reference into this specification.

Each of these conventional methods has shortcomings, however. Term-based methods are biased towards pages whose content or display is carefully chosen towards the given term-based method. Thus, they can be easily manipulated by the designers of the web page. Link-based methods have the problem that relatively new pages have usually fewer hyperlinks pointing to them than older pages, which tends to give a lower score to newer pages. There exists, therefore, a need to develop other techniques for determining the importance of documents when ordering documents in response to a search query.

In addition, conventional methods do not account for statistically predictable similarities and/or differences between users who initiate a search when ordering the results for those users. For example, a user of a particular age is likely to prefer different documents in response to a search query as compared to a user of a substantially different age who enters the same search query. For example, a seven year old boy searching the phrase “Star Wars” is likely to prefer different documents than a fifteen year old boy, a twenty five year old man, or a fifty year old man. In fact, each of the seven year old, the fifteen year old, the twenty five year old, and the fifty year old are likely to prefer very different sets of documents in response to the same search query. At the same time, two seven year old children are likely to prefer somewhat similar documents as compared to the documents preferred by a seven year old and a fifty year old. This is because seven year old children are more likely to have similar perspectives, maturity levels, intellectual levels, and interests as compared to a seven year old and a fifty year old. Similarly, a user of a particular gender is likely to prefer different documents in response to a search query as compared to a user of the opposite gender who enters the same search query. For example, a male user searching the phrase “exercise” is likely to prefer different documents than a female user searching the same phrase. This is because same gender users are more likely to have similar perspectives and interests with respect to certain topics as compared to different gender users. There exists, therefore, a substantial need to develop new techniques for ordering documents that account for statistically predictable similarities and/or differences between users.

### SUMMARY

Several embodiments disclosed herein address the needs above as well as other needs by providing methods and apparatus for using user gender and/or age group to improve the organization of documents retrieved in response to a search query.

One embodiment exemplarily disclosed herein provides a computer implemented method of organizing a set of documents that includes receiving a search query from a user and obtaining identified-age data for the user. The identified-age data includes information describing an age of the user. A set of documents, responsive to the search query, is then identified and a score is assigned to each identified document based upon a correlation between age-usage data for each document and identified-age data. The age-usage data describes at least one of a number and frequency of users who have previously accessed the document who are of a particular age or age group. Subsequently, the documents are organized based at least in part on the assigned score.

Another embodiment exemplarily disclosed herein provides a computer implemented method of organizing a set of documents that includes receiving a search query from a user and obtaining identified-gender data for the user. The identified-gender data includes information describing a gender of the user. A set of documents, responsive to the search query, is then identified and a score is assigned to each identified document based upon a correlation between gender-usage data for each document and identified-gender data. The gender-usage data describes at least one of a number and frequency of users who have previously accessed the document who are of a particular gender. Subsequently, the documents are organized based at least in part on the assigned score.

Still another embodiment exemplarily disclosed herein provides an apparatus for organizing a collection of documents that includes circuitry having executable program instructions and at least one processor configured to execute the program instructions to perform operations of receiving a search query from a user, obtaining identified-age data for the user, identifying a set of documents responsive to the search query, assigning a score to each identified document based upon a correlation between age-usage data for each document and identified-age data, and organizing the documents based at least in part on the assigned score.

Yet another embodiment exemplarily disclosed herein provides an apparatus for organizing a collection of documents that includes circuitry having executable program instructions and at least one processor configured to execute the program instructions to perform operations of receiving a search query from a user, obtaining identified-gender data for the user, identifying a set of documents responsive to the search query, assigning a score to each identified document based upon a correlation between gender-usage data for each document and identified-gender data, and organizing the documents based at least in part on the assigned score.

Yet a further embodiment exemplarily disclosed herein provides an apparatus for organizing a collection of documents that includes circuitry having executable program instructions and at least one processor configured to execute the program instructions to perform operations of receiving a search query from a user, obtaining identified-age data and identified-gender data for the user, identifying a set of documents responsive to the search query, assigning a score to each identified document based upon a correlation between age-usage data for each document and identified-age data and upon a correlation between gender-usage data for each document and identified-gender data, and organizing the documents based at least in part on the assigned score.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 illustrates a system in which numerous embodiments of methods and apparatus disclosed herein may be implemented;

FIG. 2 illustrates an exemplary client device shown in FIG. 1;

FIG. 3A illustrates a flow diagram describing an exemplarily method for organizing documents based in part on an identified gender of a user and gender-usage data relationally associated with a document;

FIG. 3B illustrates a flow diagram describing an exemplarily method for organizing documents based in part on an identified age group of a user and age-usage data relationally associated with a document;

FIG. 4 illustrates a few techniques suitable for computing the frequency of visits;

FIG. 5 illustrates a few techniques suitable for computing the number of unique users; and

FIG. 6 depicts three exemplary documents retrieved in response to an internet search employing methods and apparatus disclosed herein.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments exemplarily disclosed herein. Also, common but well-understood elements that are useful or necessary in a commercially feasible embodiment are often not depicted in order to facilitate a less obstructed view of these various embodiments exemplarily disclosed herein.

### DETAILED DESCRIPTION

The following description is not to be taken in a limiting sense, but is made merely for the purpose of describing the general principles of exemplary embodiments. The scope of the invention should be determined with reference to the claims.

According to numerous embodiments disclosed herein, a method of organizing a set of documents (e.g., a set of web pages) generally includes receiving a search query from a user, identifying a set or list of documents responsive to the search query, assigning a score to each responsive document, and organizing the documents based on the assigned scores.

In one embodiment, the responsive documents may be identified based on a comparison between the search query and the contents of the documents, or by other conventional methods.

In one embodiment, each identified document is assigned a score based in whole or in part upon a degree of correlation between data indicating an identified age group for the user (i.e., “identified-age data”) and “age-usage data” that is relationally associated with the document.

The identified-age data may include, for example, an annual age of the user or a range of annual ages within which the user's annual age falls. Identified-age data may be obtained either from a local or remote store of data or through a query to the user prior to or during the search. Accordingly, the identified-age data may include data indicating the annual age of the user or a range of annual ages that the user's annual age has been identified to fall within one of a plurality of annual age ranges (e.g., under 8 years old, 8 to 12 years old, 13 to 15 years old, 16 to 18 years old, 19 to 25 years old, 26 to 35 years old, 36 to 45 years old, 46 to 60 years old, and over 60 years old).

The identified-age data may also include an “age-correlation factor” that indicates the degree of statistical relevance that age has for predicting the document preference for that particular user. In one embodiment, the age-correlation factor may be a number between 0 and 1 that indicates a degree of statistical relevance that age has to predicting the document preference of that user, wherein the larger the number the more statistical relevance. For example, a user's age may be highly relevant in predicting the documents that the user may prefer. Accordingly, the age-correlation factor for such a user may be set to 0.88, for example. In other cases, a user's age may be only mildly relevant in predicting the documents that a user may prefer. Accordingly, the age-correlation factor for such a user may be set to 0.24, for example. In yet another embodiment, no age-correlation factor is used.

The age-usage data may include data indicating how many users visited a document (e.g., over a predetermined period of time) and/or how often users visited the page (e.g., over a predetermined period of time), such data (collectively referred to as “visit data”) being correlated with the identified age group of those users who have accessed the document Accordingly, age-usage data records not just how often a document is accessed, but how often it is accessed by users of a particular age group.

By determining and storing age-usage data, the methods and systems disclosed herein can further optimize the ordering of search results for a given user based upon that user's identified age group. For example, if a user makes a query to the search methods and systems disclosed herein, and that user has identified-age data that identifies him or her as being between 19 and 25 years old, the ordering of search results presented to that user may then be based in whole or in part upon the frequency and/or number of times that other users who are also identified as being 19 to 25 years old have accessed a given web page. In this way, data indicating the identified age group of the user can be used in conjunction with age-usage data to better order and present search results to that user.

In another embodiment disclosed herein, each identified document is assigned a score based in whole or in part upon a degree of correlation between data indicating an identified gender of the user (i.e., “identified-gender data”) and “gender-usage data” that is relationally associated with the document.

The identified-gender data may, for example, include a single variable indicating whether the user is male or female. Identified-gender data may be obtained either from a local or remote store of data or through a query to the user prior to or during the search.

The identified-gender data may also include a “gender-correlation factor” that indicates the degree of statistical relevance that gender has for predicting the document preference for that particular user. In one embodiment, the gender-correlation factor may be a number between 0 and 1 that indicates a degree of statistical relevance that gender has to document preference for that user, wherein the larger the number the more statistical relevance. For example, a user's gender may be highly relevant in predicting the documents that the user may prefer. Accordingly, the gender-correlation factor for such a user may be set to 0.90, for example. In other cases, a user's gender may be only mildly relevant in predicting the documents that a user may prefer. Accordingly, the gender-correlation factor may for such a user be set to 0.27, for example. In still other cases, gender may be inversely correlated with the typically predicted documents that a user may prefer. Accordingly, the gender-correlation factor for such a user may be set to −0.33 for example, indicating that the user's preference is mildly correlated to the opposite gender indicated by identified-gender data. In yet another embodiment, no gender-correlation factor is used.

The gender-usage data may include data indicating how many users visited a document (e.g., over a predetermined period of time) and/or how often users visited the page (e.g., over a predetermined period of time), such data (i.e., collectively referred to as visit data) being correlated with the identified gender of those users who have accessed the document. Accordingly, gender-usage data records not just how often a document is accessed, but how often it is accessed by users of a particular gender.

In one embodiment, gender-usage data is represented as a single variable that indicates the percentage of users who visit the site that are of a particular gender. Because there are only two genders (i.e., male and female), either may be chosen as the basis for this variable with the understanding that the remaining percentage of users are of the other gender. For example, a single “percent-male” variable may be used that indicates the percentage of users who visit a particular document who are male. If a value of the percent-male variable was computed as 64%, it can be inferred that the remaining 36% of visitors are female. In this way, a single variable can be used to represent the percentage of male and female visitors. The percent-male variable may be computed based upon the number of visitors or the frequency of visitors. The percent-male variable may be computed for visitors over a particular period of time, for example over the last 24 hours, over the last seven days, or over the last six months. In one embodiment, multiple percent-male variables may be computed using the number of visitors, the frequency of visitors, and/or different lengths of time for which the visits occurred.

In another embodiment, the gender-usage data may be represented as a single variable that indicates the ratio of male to female visitors who visit the site. For example, a single “gender-ratio” variable may be defined as the number of male visitors over a particular period of time divided by the number of female visitors over that period of time. Alternately, the gender-ratio variable may be defined as the frequency of male visitors over a particular period of time divided by the frequency of female visitors over a particular period of time.

In some cases (e.g., in cases where users do not choose to identify their gender when performing a search), there may actually be three different gender possibilities for a visitor to a particular document—male, female, and unknown. Accordingly, numerous embodiments disclosed herein may be adapted to compute gender-usage data for a document. In one embodiment, the gender-usage data may be computed based only upon the visitors of known gender. For example, a value of the percent-male variable may be computed similarly as described above, but by using the percentage of known male visitors divided by the total sum of known male and known female visitors. Similarly, a value of the gender-ratio variable may be computed as described above, but by using the number of known male visitors divided by the number of known female visitors.

In some cases, gender-usage data can become distorted if it is computed using only known male and female visitors and if one gender is statistically more likely to disclose their gender than the other gender. For example, if more males disclosed their gender than females, a larger percentage of female visitors would go uncounted and the values of the percent-male or gender-ratio variables described above would become distorted to indicate a greater male gender preference to a document than is actually true. Accordingly, numerous embodiments disclosed herein may be adapted to employ a “gender-correction value” to account for differences in male and female gender disclosure tendencies. For example, if historical analysis indicates that male users are 20% more likely to disclose their gender than female users, the count given to female users (in number or frequency) can be multiplied by a gender correction value of 1.2. In this way, the number of female users is increased to represent the fact that a larger percentage of female users are in the unknown group. Once this correction value is used to adjust the number of female users, values of the percent-male or gender-ratio variables may be computed as described above with likely greater accuracy with respect to the known and unknown values.

By determining and storing gender-usage data as described in the paragraphs above, the methods and systems disclosed herein can further optimize the ordering of search results for a given user based upon that user's identified gender. For example, if a user makes a query to the search methods and systems disclosed herein, and that user has identified-gender data that identifies him as male, the ordering of search results presented to that user may then be based in whole or in part upon the frequency and/or number of times that other users who are also identified as male have accessed a given web page. In this way, the data indicating the identified gender of the user can be used in conjunction with gender-usage data to better order and present search results to that user.

In another embodiment disclosed herein, both the identified-age data and the identified-gender data for the user are used, at least in part, to assign scores to documents that are retrieved in response to a search query. For example, each identified document may be assigned a score based in whole or in part upon: 1) a degree of correlation between identified-gender data of the user and gender-usage data that is relationally associated with the document; and 2) upon a degree of correlation between identified-age data of the user and age-usage data that is relationally associated with the document. In this way, the combined effect of a user's age and gender upon predicted document preference may be used to better order the documents in response to a search query. In one such embodiment, age and gender correlations are equally weighted in their effect upon document ordering. In another such embodiment, weighting factors are used such that age and gender correlations have differing amounts of effect upon document ordering. In another embodiment, a user belonging to certain age groups has a larger effect upon the ordering of documents as compared to the user belonging to other age groupings. For example, in certain embodiments the younger the age grouping that a user belongs to, the more effect that age correlation has upon the ordering of documents in the search results.

According to one embodiment disclosed herein, a method is provided for adjusting the identified-age data and/or age-correlation factor for a user based upon a history of document preferences and a correlation with the documents preferred by other users of certain ages and/or certain age groups. In this way, a user may be assigned an identified age group that is different from his or her chronological age. Such a method may be implemented to improve search results for users who are behaviorally more similar to users who are older or younger than themselves. Similarly, and in accordance with another embodiment disclosed herein, a method is provided for adjusting the identified-gender data and/or the gender-correlation factor for a user based upon a history of document preferences and a correlation with the documents preferred by other users of a certain gender. In this way, a user may be assigned an identified gender that is different from his or her biological gender. Such a method may be implemented to improve search results for users who are behaviorally more similar to users who are of the opposite gender than themselves.

According to another embodiment disclosed herein, a method is provided for predicting the gender of a particular user based at least in part upon correlations between that user's document preferences and stored gender-usage data for a plurality of documents. Similarly, and in accordance with another embodiment disclosed herein, a method is provided for predicting the age or age grouping of a particular user based at feast in part upon correlations between that user's document preferences and stored age-usage data for a plurality of documents.

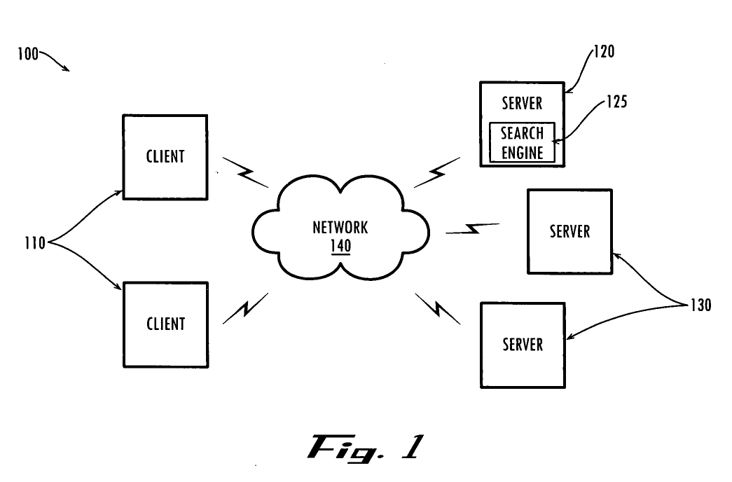

Having generally described numerous embodiments above, an exemplary system in which these embodiments can be implemented will now be described with respect to FIG. 1.

Referring to FIG. 1 a system 100 adapted to implement the aforementioned embodiments may, for example, include multiple client devices 110 connected to multiple servers 120 and 130 via a network 140. The network 140 may include a local area network (LAN), a wide area network (WAN), a telephone network, such as the Public Switched Telephone Network (PSTN), an intranet, the Internet, or a combination of networks. Two client devices 110 and three servers 120 and 130 have been illustrated as connected to network 140 for simplicity. In practice, there may be more or less client devices and servers. Also, in some instances, a client device may perform the functions of a server and a server may perform the functions of a client device.

The client devices 110 may include devices, such mainframes, minicomputers, personal computers, laptops, personal digital assistants, or the like, capable of connecting to the network 140. The client devices 110 may transmit data over the network 140 or receive data from the network 140 via a wired, wireless, or optical connection.

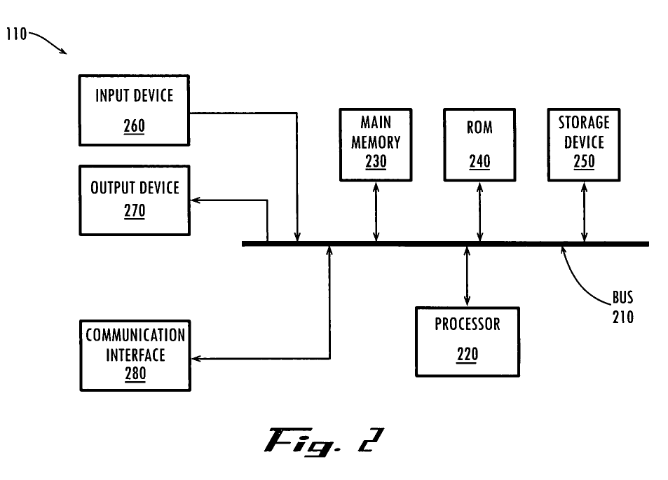

Referring to FIG. 2, the client device 110 shown in FIG. 1 may include a bus 210, a processor 220, a main memory 230, a read only memory (ROM) 240, a storage device 250, an input device 260, an output device 270, and a communication interface 280.

The bus 210 may include one or more conventional buses that permit communication among the components of the client device 110. The processor 220 may include any type of conventional processor or microprocessor that interprets and executes instructions. The main memory 230 may include a random access memory (RAM) or another type of dynamic storage device that stores information and instructions for execution by the processor 220. The ROM 240 may include a conventional ROM device or another type of static storage device that stores static information and instructions for use by the processor 220. The storage device 250 may include a magnetic and/or optical recording medium and its corresponding drive.

The input device 260 may include one or more conventional mechanisms that permit a user to input information to the client device 110, such as a keyboard, a mouse, a pen, voice recognition and/or biometric mechanisms, etc. The output device 270 may include one or more conventional mechanisms that output information to the user, including a display, a printer, a speaker, etc. The communication interface 280 may include any transceiver-like mechanism that enables the client device 110 to communicate with other devices and/or systems. For example, the communication interface 280 may include mechanisms for communicating with another device or system via a network, such as network 140.

As will be described in detail below, the client devices 110 may perform certain document retrieval operations. The client devices 110 may perform these operations in response to processor 220 executing software instructions contained in a computer-readable medium, such as memory 230. A computer-readable medium may be defined as one or more memory devices and/or carrier waves. The software instructions may be read into memory 230 from another computer-readable medium, such as the data storage device 250, or from another device via the communication interface 280. The software instructions contained in memory 230 causes processor 220 to perform search-related activities described below. Alternatively, hardwired circuitry may be used in place of or in combination with software instructions to implement processes exemplarily described herein. Thus, embodiments disclosed herein are not limited to any specific combination of hardware circuitry and software.

The servers 120 and 130 may include one or more types of computer systems, such as a mainframe, minicomputer, or personal computer, capable of connecting to the network 140 to enable servers 120 and 130 to communicate with the client devices 110. In other implementations, the servers 120 and 130 may include mechanisms for directly connecting to one or more client devices 110. The servers 120 and 130 may transmit data over network 140 or receive data from the network 140 via a wired, wireless, or optical connection.

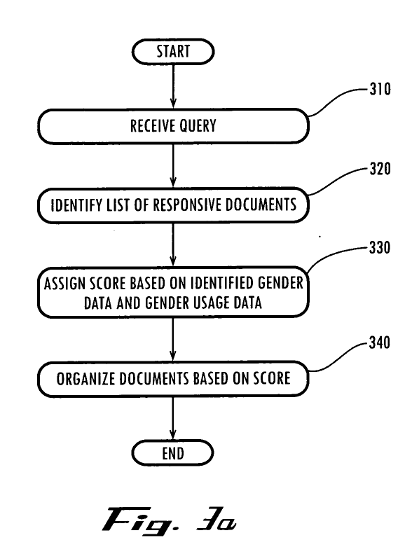

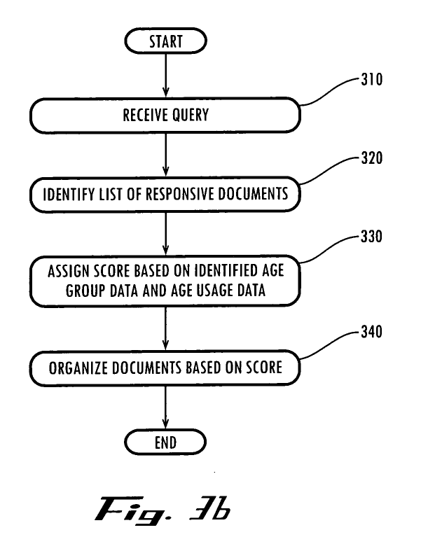

The servers may be configured in a manner similar to that described above in reference to FIG. 2 for client device 110. In one embodiment, the server 120 may include a search engine 125 usable by the client devices 110. The servers 130 may store documents (e.g., web pages) accessible by the client devices 110 and may perform document retrieval and organization operations, as described below with respect to FIGS. 3A to 6.

Referring to FIG. 3A, a flow diagram describes an exemplary method for organizing documents based on an identified gender of a user performing a search and gender-usage data relationally associated with documents (e.g., web pages) that are retrieved during the search. At 310, a search query is received by the search engine 125 as entered by the user. The query may contain text, audio, video, or graphical information. At 320, the search engine 125 identifies a set or list of documents that are responsive (or relevant) to the search query. The set of responsive documents may be identified in any manner (e.g., by comparing the search query to the content of the document).

Once identified, the set of responsive documents are, in one embodiment, organized using the identified-gender data of the user, in whole or in part. In another embodiment, the set of responsive documents are organized using gender-usage data, in whole or in part. In another embodiment, the set of responsive documents are organized using both the identified gender of the user and gender-usage data, in whole or in part. Thus, at 330, scores are assigned to each document based upon how well the gender-usage data relationally associated with each document correlates with the identified-gender data of the user who is performing the search. The scores may be absolute in value or relative to the scores for other documents. The scores are weighed based upon the level or degree of correlation determined. For example, a web site relationally associated with gender-usage data indicating heavy usage by male users as compared to female users will be determined to correlate strongly with a user who has an identified gender as male. Alternately, a web site relationally associated with gender-usage data indicating low usage by male users as compared to female users will be determined to correlate weakly with a user who has an identified gender as male. In this way, a higher score can be assigned to a document that shows a strong correlation between gender-usage data and identified gender as compared to a document that shows weaker correlation between gender-usage data and identified gender. In addition, a gender-correlation factor may be taken into account in the computation of such scores. For example, a user that has a high gender-correlation factor may have a greater difference in computed scores based upon the correlation between gender-usage data and identified gender as compared to a user who has a low gender-correlation factor value associated with him or her. In another embodiment, an “inverse gender-correlation factor” may be used to reverse the aforementioned scoring method, awarding a higher score for a weaker gender correlation and a lower score for a stronger gender correlation. In this way, the documents may be scored based upon the correlation between identified gender of the user and the gender-usage data for the document, with optional consideration of a gender-correlation factor that represents the predictive value of gender correlation for the particular user who performed the search.

For illustrative purposes only, the following exemplary implementation of the embodiment described above will now be provided. A search query may be entered by a user who is identified as male (i.e., identified gender=male). In response to this search query, the search engine identifies a number of documents. One particular document may have gender-usage data that indicates that the percentage of male users (i.e. percent-male) is computed as 82%. Another particular document may have gender-usage data that indicates that the percentage of male users is computed as 21%. Thus, the first aforementioned document has a strong correlation between gender-usage data and the identified gender of the user and the second aforementioned document has a weak correlation between the gender-usage data and the identified gender of the user. The first document is therefore assigned a higher score at 330 than the second document. A scoring method may be employed in which the percentage of visitors in the gender-usage data who are of the user's gender is translated directly into a score value. For example, the first document may be assigned a score of 82 while the second document may be assigned as a score of 21. Accordingly, the gender-correlation factor is not used. In fact, the gender-correlation factor may be used in later stages wherein the effect of gender is weighted with respect to other factors that may influence the ordering of documents.

Referring back to FIG. 3A, a score can be assigned at 330 based on a variety of gender-usage data and identified-gender data. In one embodiment, the gender-usage data comprises information about both the number of unique visits and the frequency of visits of users of particular genders. For example, the gender-usage data may include data about not only how many unique visitors of a particular gender have visited a site during a particular time period, but also the frequency. The correlations can be stored as absolute numbers or as relative percentages.

In one embodiment, the gender-usage data and identified-gender data may be maintained at client 110 and transmitted to search engine 125. In another embodiment, the gender-usage data may be maintained upon a server 130 and the identified-gender data may be maintained upon client 110. In another embodiment, both gender-usage data and identified-gender data may be maintained upon a server 130. The location of the gender-usage data and identified-gender data (collectively referred to herein as “gender information”) is not critical and it will be appreciated that the gender information can be maintained in many other ways. For example, the gender-usage data may be maintained at servers 130 which forward the information to search engine 125; or the gender-usage data may be maintained at server 120 if it provides access to the documents (e.g., as a web proxy).

At 340, the responsive documents are organized based on the assigned scores. In one embodiment, the documents are organized based entirely on the scores derived from gender-usage data relationally associated with the retrieved web pages and the identified gender of the user who has initiated the search. In another embodiment, the documents are organized based on the assigned scores in combination with other factors. For example, the documents may be organized based on the assigned scores combined with link information and/or query information. Link information involves the relationships between linked documents, and an example of the use of such link information is described in the Brin & Page publication referenced above. Query information involves the information provided as part of the search query, which may be used in a variety of ways to determine the relevance of a document. Other information, such as the length of the path of a document, could also be used. In addition, the relative importance of the assigned score based on the gender information with the other factors used in ordering the documents is a variable that may be set, assigned, or derived.

In one embodiment, the relative importance of the assigned score based on the gender information, as compared to other factors used in ordering the document is based in whole or in part upon a gender-correlation factor value that is associated with the user who performed the search. Accordingly, the effect that the assigned score based on the gender information has upon ordering of the document as compared to the affect that other factors have upon ordering of the documents is dependent upon the gender-correlation factor, wherein the higher the gender-correlation factor, the greater the effect that the assigned score based on the gender information has as compared to other factors used in ordering.

In one implementation, documents are organized based on a total score that represents the product of a “gender-usage score” and a standard query-term-based score (“IR score”). The gender-usage score may be weighted based upon the gender-correlation factor prior to computation of the total score. In one embodiment, the total score equals the square root of the IR score multiplied by the weighted gender-usage score. The gender-usage score, in turn, equals a frequency of visit score (weighed by a degree of correlation with identified gender of the user) multiplied by a unique user score (also weighed by a degree of correlation with identified gender) multiplied by a path length score (optionally weighted by a degree of correlation with identified gender).

In one embodiment, a first frequency of visit score equals log2(1+log(VF)/log(MAXVF). VF is the number of times that the document was visited (or accessed) in one month, and MAXVF is set to 2000. In this embodiment, a second frequency of visit score is calculated not based upon the total number of visits, but calculated based upon a correlation with the searching user's identified gender and the gender-usage data stored related to the document in question. For example, if the identified gender of the user who initiated the search indicates that that user is a male, the gender-usage data stored for the document in question will compute a frequency of visit score equal to log2(1+log(VF1)/log(MAXVF1) where VF1 is the number of times that the document was visited (or accessed) in one month by other unique users who had identified-gender data identifying them as males, and MAXVF1 is set to 2000. A final frequency of visit score is then computed based upon the first frequency of visit score and the second frequency of visit score, scoring this site based both on the total number of visits as well as the number of visits by males, the gender of the user who initiated the search. It should be noted that numerous other factors may be considered in computing visit scores other than gender. For example, the user's identified age group may be used to compute a second factor such that gender and age may be considered simultaneously in determining the score for a particular user based upon the correlation of both gender and age. Age will be described in more detail with respect to FIG. 3B. Moreover, other factors can also be used in the methods disclosed herein, each for example being used to compute a third, forth, and further frequency of visit scores.

As for computing visitor frequency values, the following is one method of doing so. VF is computed as being equal to 0.5*(1+UU/MAXUU) where UU is the number of unique visitors that access the document in one month, and MAXUU is set to a reasonable constant such as 400. A small value is used when UU is unknown. VF1 is computed as being equal to 0.5*(1+UU1/MAXUU1) where UU1 is the number of unique visitors who have identified-gender data identifying them as Male that access the document in one month, and MAXUU1 is set to a reasonable constant such as 400. The number of unique visitors can be determined by monitoring host/IP data and/or other user identification data. The path length score may be computed in a traditional way, for example equal to log(K−PL)/log(K). PL is the number of ‘/’ characters in the document's path, and K is set to 20.

Referring next to FIG. 3B, a flow diagram describes an exemplary method for organizing documents based on an identified age group of a user performing a search and age-usage data relationally associated with documents (e.g., web pages) that are retrieved during the search. At 310, a search query is received by the search engine 125 as entered by the user. The query may contain text, audio, video, or graphical information. At 320, the search engine 125 identifies a set or list of documents that are responsive (or relevant) to the search query. The set of responsive documents may be identified in any manner (e.g., by comparing the search query to the content of the document).

Once identified, the set of responsive documents are, in one embodiment, organized using the identified-age data of the user, in whole or in part. In another embodiment, the set of responsive documents are organized using age-usage data, in whole or in part. In another embodiment, the set of responsive documents are organized using both the identified age group of the user and age-usage data, in whole or in part. Thus, at 330, scores are assigned to each document based upon how well the age-usage data, relationally associated with each document, correlates with the identified-age data of the user who is performing the search. The scores may be absolute in value or relative to the scores for other documents. The scores are weighed based upon the level or degree of correlation determined. For example, a web site that has age-usage data that shows heavy usage by users of the age group 12 to 15 years old as compared to users of other age groups will be determined to correlate strongly with a user who has an identified age group as being within 12 to 15 years old. Alternately, a web site that has age-usage data that shows low comparative usage by users of the age group 12 to 15 years old as compared to users of other age groups will be determined to correlate weakly with a user who has an identified age group as being within 12 to 15 years old. In this way, a higher score can be assigned to a document that shows a strong correlation between age-usage data and identified age group as compared to a document that shows weaker correlation between age-usage data and identified age group. In addition, an age-correlation factor may be taken into account in the computation of such scores. For example, a user that has a high age-correlation factor may have a greater difference in computed scores based upon the correlation between age-usage data and identified-age data as compared to a user who has a low age-correlation factor value associated with him or her. In this way, the documents may be scored based upon the correlation between identified-age data of the user and the age-usage data for the document, with optional consideration of an age-correlation factor that represents the predictive value of age grouping correlation for the particular user who performed the search.

For illustrative purposes only, the following exemplary implementation of the embodiment described above will now be provided. A search query may be entered by a user who is identified as under 8 years old (i.e., identified age group=under 8 years old). In response to this search query, the search engine identifies a number of documents. One particular document may have age-usage data that indicates that the percentage of users who are in the age group under 8 years old is 62%. Another particular document may have age-usage data that indicates that the percentage of users who are in the age group under 8 years old computed as 8%. Thus, the first aforementioned document has a strong correlation between age-usage data and the identified age group of the user and the second aforementioned document has a weak correlation between the age-usage data and the identified age group of the user. The first document is therefore assigned a higher score at 330 than the second document. A scoring method may be employed in which the percentage of visitors in the age-usage data who are of the user's age group is translated directly into a score value. For example, the first document may be assigned a score of 62 while the second document may be assigned as a score of 8. Accordingly, the age-correlation factor is not used. In fact, the age-correlation factor may be used in later stages wherein the effect of age is weighted with respect to other factors that may influence the ordering of documents.

Referring back to FIG. 3B, a score can be assigned at 330 based on a variety of age-usage data and identified-age data. In one embodiment, the age-usage data comprises information about both the number of unique visits and the frequency of visits of users of particular ages and/or age groups. For example, the age-usage data may include data about not only how many unique visitors of a particular age grouping have visited a site during a particular time period, but also the frequency. The correlations can be stored as absolute numbers or as relative percentages.

In one embodiment, the age-usage data and identified-age data may be maintained at client 110 and transmitted to search engine 125. In another embodiment, the age-usage data may be maintained upon a server 130 and the identified-age data may be maintained upon client 110. In another embodiment, both age-usage data and identified-age data may be maintained upon a server 130. The location of the age-usage data and identified-age data (collectively referred to herein as “age information”) is not critical and it will be appreciated that the age information can be maintained in many other ways. For example, the age-usage data may be maintained at servers 130 which forward the information to search engine 125; or the age-usage data may be maintained at server 120 if it provides access to the documents (e.g., as a web proxy).

At 340, the responsive documents are organized based on the assigned scores. In one embodiment, the documents are organized based entirely on the scores derived from age-usage data relationally associated with the retrieved web pages and the identified age group of the user who has initiated the search. In another embodiment, the documents are organized based on the assigned scores in combination with other factors. For example, the documents may be organized based on the assigned scores combined with link information and/or query information. Link information involves the relationships between linked documents, and an example of the use of such link information is described in the Brin & Page publication referenced above. Query information involves the information provided as part of the search query, which may be used in a variety of ways to determine the relevance of a document. Other information, such as the length of the path of a document, could also be used. In addition, the relative importance of the assigned score based on the age information with the other factors used in ordering the documents is a variable that may be set, assigned, or derived.

In some embodiments, the relative importance of the assigned score based on the age information, as compared to other factors used in ordering the document is based in whole or in part upon an age-correlation factor value that is relationally associated with the user who performed the search. Accordingly, the effect that the assigned score based on the age information has upon ordering of the document as compared to the affect that other factors have upon ordering of the documents is dependent upon the age-correlation factor, the higher the age-correlation factor, the greater the effect that age grouping score has as compared to other factors used in ordering.

In one implementation, documents are organized based on a total score that represents the product of an “age-usage score” and a standard query-term-based score (“IR score”). The age-usage score may be weighted based upon the age-correlation factor prior to computation of the total score. In some embodiments the total score equals the square root of the IR score multiplied by the weighted age usage score. The age-usage score, in turn, equals a frequency of visit score (weighed by a degree of correlation with identified age group of the user) multiplied by a unique user score (also weighed by a degree of correlation with identified age group) multiplied by a path length score (optionally weighted by a degree of correlation with identified age group).

In one embodiment a first frequency of visit score equals log2(1+log(VF)/log(MAXVF). VF is the number of times that the document was visited (or accessed) in one month, and MAXVF is set to 2000. In this embodiment a second frequency of visit score is calculated not based upon the total number of visits, but calculated based upon a correlation with the searching user's identified age group and the age-usage data stored related to the document in question. For example, if the identified age group of the user who initiated the search indicates that that user is over 65 years old, the age-usage data stored for the document in question will compute a frequency of visit score equal to log2(1+log(VF1)/log(MAXVF1) where VF1 is the number of times that the document was visited (or accessed) in one month by other unique users who had identified-age data identifying them as over 65 years old, and MAXVF1 is set to 2000. A final frequency of visit score is then computed based upon the first frequency of visit score and the second frequency of visit score, scoring this site based both on the total number of visits as well as the number of visits by users over 65 years old, the age group of the user who initiated the search. It should be noted that numerous other factors may be considered in computing visit scores other than age group. For example the user's gender may be used to compute a second factor such that gender and age may be considered simultaneously in determining the score for a particular user based upon the correlation of both gender and age. Gender was described in more detail with respect to FIG. 3A. Moreover, other factors can also be used in the methods disclosed herein, each for example being used to compute a third, forth, and further frequency of visit scores.

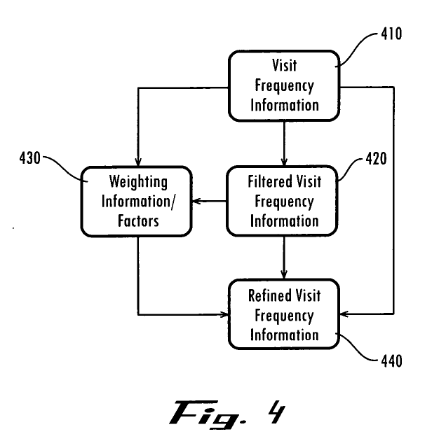

Referring next to FIG. 4, exemplary techniques suitable for computing the frequency of visits to a document (e.g., a web site) as correlated with identified gender or identified age group of users who visit the document will now be discussed. The computation begins with one or more counts at 410, one of which may be a raw count and may be an absolute or relative number corresponding to the visit frequency for the document. For example, the raw count may represent the total number of times that a document has been visited. Alternatively, the raw count may represent the number of times that a document has been visited in a given period of time (e.g., over the past week), the change in the number of times that a documents has been visited in a given period of time (e.g., 20% increase during this week compared to the last week), or any number of different ways to measure how frequently a document has been visited. In one embodiment, the raw count is used as the refined visit frequency at 440, as shown by the path from 410 to 440.

In addition to the raw count as described above at 410, an identified gender count and/or identified age group count is also available at 410. Each of the counts could be an absolute or relative number corresponding to the visit frequency of users who visited the document of a particular gender or age group respectively. For example if the identified gender of a user visiting a specific document is male, a gender count associated with the gender male would be increased by one. In this way gender count variables can be initialized and incremented, tallying the number of visitors who are identified as a particular gender. Alternatively, the count may represent the number of times that a document has been visited by users who are identified as male in a given period of time (e.g., over the past week), the change in the number of times that a documents has been visited by users who are identified as male (e.g., 20% increase during this week compared to the last week), or any number of different ways to measure how frequently a document has been visited by users who have identified-gender data that indicates they are male. In one exemplary embodiment, this count is used as the refined visit frequency. The counting of the total number of visits is described in the previous paragraph as the raw count The counting of the number of visits as correlated with a particular gender is referred to herein as an identified gender count. The counting the number of visits as correlated with a particular age group is referred to herein as an identified age count.

In other embodiments, the raw count and/or identified gender count and/or the identified age count may be processed using any of a variety of techniques to develop a refined visit frequency for each, with a few such techniques being illustrated in FIG. 4. As shown at 420, the raw count and/or identified gender count and/or identified age count may be filtered to remove certain visits. For example, one may wish to remove visits by automated agents or by those affiliated with the document at issue, since such visits may be deemed to not represent objective usage. The filtered count at 420 may then be used to calculate the refined visit frequency at 440.

Instead of, or in addition to, filtering the raw count and/or the identified age count and/or the identified gender count, each count may be weighted based on the nature of the visit at 430. For example, one may wish to assign a weighting factor to a visit based on the geographic source for the visit (e.g., counting a visit from Germany as twice as important as a visit from Antarctica). Any other type of information that can be derived about the nature of the visit (e.g., the browser being used, the search engine from which the visit originated, the language being used by the user to perform the search, or other information concerning the user, etc.) could also be used to weight the visit. This weighted visit frequency at 430 may then be used as the refined visit frequency at 440.

Although only a few techniques for computing the visit frequency have been described above with respect to FIG. 4, those skilled in the art will recognize that visit frequency may be calculated in numerous other ways.

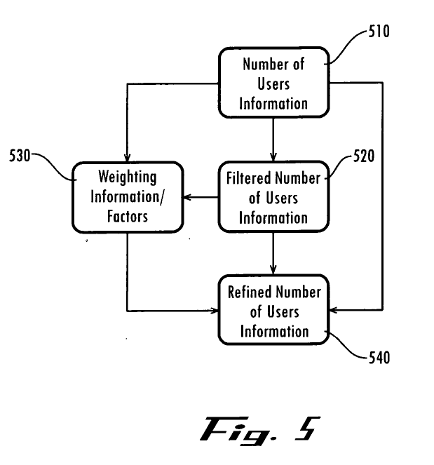

Referring next to FIG. 5, exemplary techniques suitable for computing the total number of unique users who have visited a document (e.g., a web site) as correlated with the number of unique users of a particular identified gender or identified age group will now be discussed. As similarly discussed with respect to techniques for computing visit frequency, the total number of unique users can be calculated by first obtaining one or more counts at 510, one of which may be a raw count and may be an absolute or relative number corresponding to the number of unique users who have visited the document. Alternatively, the raw count may represent the number of unique users that have visited a document in a given period of time (e.g., 30 users over the past week), the change in the number of unique users that have visited the document in a given period of time (e.g., 20% increase during this week compared to the last week), or any number of different ways to measure how many unique users have visited a document. The identification of the unique users may be achieved based on the user's Internet Protocol (IP) address, their hostname, cookie information, or other user or machine identification information. In one embodiment, the raw count is used as the refined number of users at 540, as shown by the path from 510 to 540.

In addition to the raw count as described above at 510, an identified gender count and/or an identified age count is also available at 510. Each of the counts could be an absolute or relative number corresponding to the visit frequency of users who visited the document who had a certain gender indicated in their identified-gender data or had a certain age group indicated within their identified-age data respectively. For example, if the identified-gender data of a unique user visiting a specific document includes is set to male, an identified gender count associated with male would be increased by one. In this way, identified gender count variables can be initialized and incremented, tallying the number of unique visitors who are male, female, or unknown in gender. For example, the count may represent the total number of times that a document has been visited by unique users whose identified-gender data that they are female. Alternatively, the count may represent the number of times that a document has been visited by unique users who are identified as female in a given period of time (e.g., over the past week), the change in the number of times that a documents has been visited by unique users who are identified as female in a given period of time (e.g., 20% increase during this week compared to the last week), or any number of different ways to measure how the number of times a document has been visited by unique users who are identified as female. In one embodiment, both identified age count and identified gender count are tallied and used simultaneously. Whereas the counting of the total number of unique visits is described in the previous paragraph as the raw count, the counting of the number of unique visits as correlated with a particular gender is referred to herein as an identified gender count and the number of unique visits correlated with a particular age grouping is referred to herein as an identified age count.

In other embodiments, the raw count and/or identified age count and/or identified gender count may be processed using any of a variety of techniques to develop a refined user count for each, with a few such techniques being illustrated in FIG. 5. As shown at 520, the raw count and/or identified gender count and/or identified age count may be filtered to remove certain users. For example, one may wish to remove users identified as automated agents or as users affiliated with the document at issue, since such users may be deemed to not provide objective information about the value of the document. The filtered count at 520 may then be used to calculate a refined user count at 540.

Instead of, or in addition to, filtering the raw count and/or the identified gender count and/or the identified age count, each count may be weighted based on the nature of the user at 530. For example, one may wish to assign a weighting factor to a visit based on the geographic source for the visit (e.g., counting a user from Germany as twice as important as a user from Antarctica). Any other type of information that can be derived about the nature of the user's visit (e.g., browsing history, bookmarked items, language used during the search, etc.) could also be used to weight the user. This weighted user information at 530 may then be used as a refined user count at 540.

Although only a few techniques for computing the number of unique users have been described above with respect to FIG. 5, those skilled in the art will recognize that the number of unique users may be calculated in numerous other ways. Furthermore, although the methods described above with respect to FIGS. 4 and 5 determine gender-usage data and/or age-usage data on a document-by-document basis, other techniques may also be used. For example, rather than maintaining gender-usage data and/or age-usage data for each document, such information may be maintained on a site-by-site basis wherein such “site-gender usage information” and/or “site-age usage information” can then be associated with some or all of the documents within that site. This reduces the amount of data that must be stored for each site.

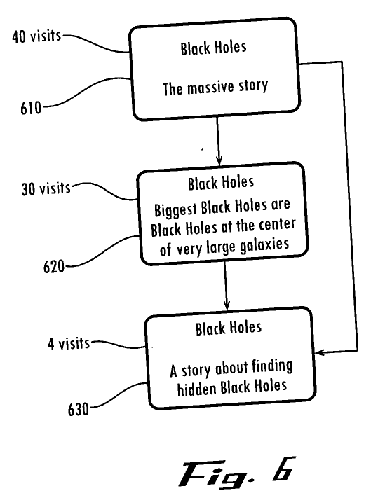

Referring next to FIG. 6, three exemplary documents, 610, 620, and 630, are depicted as being identified in response to a search query for the term “black holes”.

Document 610 is shown to have been visited 40 times over the past month, with 15 of those 40 visits being by automated agents. Of the 25 non-automated visits, this document is shown to have been visited 10 times by users who have identified-gender data identifying them as female, visited 13 times by users who have identified-gender data identifying them as male, and 2 times by users of unknown gender.

Document 620, which is linked to from document 610, is shown to have been visited 30 times over the past month. Of the 30 visits, this document is shown to have been visited 21 times by users who have identified-gender data indicating that they are male, visited 6 times by users by users who have identified-gender data indicating that they are female, and visited by 3 users of unknown gender.

Document 630, which is linked to from documents 610 and 620, is shown to have been visited 4 times over the past month. Of the 4 visits, this document is shown to have been visited 1 time by users who have identified-gender data indicating that they are male, visited 2 times by users who have identified-gender data indicating that they are female, and visited by 1 users of unknown gender.

Under a conventional term frequency based search method, the documents may be organized based on the frequency with which the search query term (“black holes”) appears in the document. Accordingly, the documents may be organized into the following order: 620 (assuming three occurrences of “black holes” were found), 630 (assuming two occurrences of “black holes” were found), and 610 (assuming one occurrence of “black holes” were found).

Under a conventional link-based search method, the documents may be organized based on the number of other documents that link to those documents. Accordingly, the documents may be organized into the following order: 630 (linked to by two other documents), 620 (linked to by one other document), and 610 (linked to by no other documents).

Under a conventional visit count method of organizing documents, the documents may be organized based upon the total number of visits to that site by non-automated agents. Accordingly, the documents may be organized into the following order 620 (visited by 30 non-automated agents), 610 (visited by 25 non-automated agents), then 630 (visited by 4 non-automated agents).

Methods and apparatus exemplarily discussed above employ both identified-gender data and gender-usage data to aid in organizing documents. For example, the methods may review the identified-gender data of the user who is currently performing the search. If the identified-gender data indicates that the user is male, then the document may be organized not based simply upon the number of visits, the number of non-automated visits, or the distribution of visits from various IP addresses in certain locations, but also upon the identified gender of the user who is performing the search (in this case male), and the number of visits to the sites by other users who were also identified as male.

Using, in the example provided above, the correlation between the male gender of the user and the number of male user visits stored in the gender-usage data for each of the documents, the documents may be organized based upon the percentage of male users (e.g., via the aforementioned percentage-male variable) who visited each document in the past. Using such a method, the documents may be ordered in the following way: document 620 (78% of the users of known gender who have visited the document were identified as male), document 610 (57% of the users of known gender who have visited the document were identified as male), and document 630 (33% of the users of known gender who have visited the document were identified as male).

Instead of using only the identified-gender data of the user and the gender-usage data for the documents, the gender data may be used in combination with the query information and/or the link information to develop the ultimate organization of the documents.

In one embodiment, both gender and age correlations may be used simultaneously to provide an even more refined ordering of documents for a user of a particular age and gender combination. For example, for a male user of age group between 19 and 25 years old performs an internet search using the methods disclosed herein. The user's identified age group and identified gender is correlated with age-usage data and gender-usage data respectively to determine the level of match between a particular document being ordered and the previous users who were also male and of an age group between 19 and 25 years old who accessed that document. Age and gender matches may organize documents in a manner that is highly correlated with user preference. For example, male users between 8 and 12 years old may have unique preferences and perspectives that are very different from female users between 8 and 12 years old and may also be very different from male users of other age groups.

In one embodiment, software included has access to identified-gender data and/or identified-age data of users who perform searches. Such data may be collected at the time the search is performed by a user or may be collected during a previous registration stage and stored (e.g., in a data store on a computer) with relational association to a user specific ID. Either way, identified-gender data for a user can be obtained by having the user simply enter his or her gender by selecting a choice from a user interface or by responding to a query. Similarly, identified-gender data for a user can be obtained by having the user enter his or her age, birth year, birth date, or age group by selecting choices from a user interface or by responding to a query. Identified-age data can then be derived from this the information provided by the user.

In one embodiment, a method is provided that additionally allows users to rate websites via rating data. Such rating data can be correlated with the users' identified-gender data or identified-age data. The ratings can optionally be prompted by the search engine (e.g., the search engine can ask the user to rate the usefulness of the document after it has been reviewed by the user). The rating data can be binary (e.g., useful/not-useful) or can be numerical (e.g., as given on a continuous “usefulness rating scale” from 1 to 10, wherein 1 is the least useful and 10 is the most useful). In this way, a user who is, for example, male and who searches for information about “exercise” can rate each document he reviews, and the rating data can be added to the store of gender-usage data relationally associated with that document. Accordingly, the gender-usage data correlates the rating data given by the user with that user's gender. In this way, the gender-usage data for the exercise document described in the example above will be updated with the rating data given by male users and by female users. For example, the average usefulness rating provided by male users for the “exercise” document may be 8.5 on the usefulness rating scale from 1 to 10. Similarly, the average usefulness rating provided by female users for the “exercise” document may be 2.5 on the usefulness rating scale from 1 to 10. Thus the “exercise” document is shown to be found highly useful by male users and minimally useful by female users. This data can be used to strengthen the correlation of the “exercise” document to male identified gender and to weaken the correlation of the “exercise” document to female identified gender. For example, the gender-usage data representing the relative number or frequency of male visitors may be scaled upward based upon the highly useful rating data provided by male users. Similarly, the gender-usage data representing the relative number or frequency of female visitors may be scaled downward based upon the minimally useful rating data provided by female users. In this way, rating data provides more accurate means for correlation between gender-usage data and identified-gender data to predict the usefulness of a given document to a particular user performing a search.

In a similar embodiment, rating data may also (or alternately) be added to the store of age-usage data relationally associated with that document stored. Accordingly, the ratings of documents may be correlated with the age groupings of the users who provide the ratings. In this way, rating data provides more accurate means for correlation between age-usage data and identified age group to predict the usefulness of a given document to a particular user performing a search.

In another embodiment, rating data can be simultaneously correlated with both gender-usage data and age-usage data to provide an even more refined ordering of documents for a user of a particular age and gender combination. For example, a male user of age group between 19 and 25 years old may be performing an internet search using the methods disclosed herein. The gender-usage data and age-usage data may be used in combination, both correlated with rating data, to determine the level of correlation between a particular document and previous users who were also male and between 19 and 25 years old.

In one embodiment, other methods may be used to derive rating data indicating the “usefulness” of a document to a user, other than simply collecting rating data from the user as a result of a direct query. For example, a “print tracking” technique may be employed as disclosed in co-pending U.S. Provisional Application No. 60/649,240. In another example, a “time spent tracking” technique may be employed as disclosed in co-pending U.S. Provisional Application No. 60/649,240.

In addition to, or instead of using gender-usage data and/or age-usage data that reflects the number of users and/or frequency of users who have visited a document of a particular identified gender and/or identified age group respectively, “assigned-gender-correlation data” and/or “assigned-age-correlation data” (collectively referred to as “assigned-correlation-data” may be set for a particular web site, wherein the assigned-correlation-data reflects the likely relevance of that site to a user of a particular gender and/or a particular age group. For example, assigned-correlation-data indicating a high correlation factor with male users of an age group between 26 and 35 years old may be set for a particular website. In one embodiment, the assigned-correlation-data may be set by an author of a document on the particular website, an owner of the document on the particular website, the host of the web document on the particular website, or by some other party. In one embodiment, the assigned-correlation-data can be stored on the server along with the web document itself or the assigned-correlation-data could be stored on a remote server or proxy server. In another embodiment, the assigned-correlation-data can be used by the algorithm that organizes the documents to more favorably order those documents that have an assigned correlation that correlates well with identified gender and/or identified age group of the user who initiated a given search.

In some cases, a user enters a query into a search engine but the search engine does not have access to identified-gender data for the user. For example, the user may have refused or neglected to enter gender data into the system. Accordingly, one embodiment provides a computational infrastructure within which the gender of a user may be accurately predicted based upon previously collected gender-usage data from other users and data reflecting the current and/or historical document visiting habits of the current user of unknown gender. The predicted gender may then be assigned to the user of unknown gender as the identified-gender of the user.

As mentioned above, the gender of a user of unknown gender can be predicted by correlating the documents that he or she is currently visiting and/or has historically visited with the gender-usage data for those documents. For example, if a user has recently visited ten web site documents, each of those documents having gender-usage data showing a strong correlation with an identified gender of male, the software is adapted to predict that the current user of unknown gender is male. Furthermore, the software can assign an identified gender to that unknown user of male. Because the gender was predicted and not provided by the user directly, the software can set a gender-correlation factor for that user to a low value. As the user visits additional sites having gender-usage data that are strongly correlated with an identified gender of male, the software routines may increase the gender-correlation factor for the user. In this way, the gender of a user may be predicted based upon the gender-usage data stored for sites and/or documents that the user visits if that data reflects a stronger correlation with one gender over the other. In addition, the software routines may assign and/or adjust a gender-correlation factor based upon the degree of correlation of the gender-usage data for web sites and/or documents that the user visits over a period of time with the predicted gender of the user.

Thus, the software may predict the gender of a user of unknown gender based upon the gender-usage data stored for documents that the user visits or has visited in the recent past and assign the predicted gender to the user as the identified-gender of the user. In one example, a user of unknown gender visits a number of documents, each of which is associated with gender-usage data. A mean or average value of gender-usage data may be computed for the number of documents that the user visited. For example, in one embodiment, a value of an “average-gender-ratio” variable may be computed for the number of documents that the user visited, wherein the “average-gender-ratio” variable represents the statistical average of values of gender-ratio variables associated with each of the number of documents visited, wherein the value of the gender-ratio variable of each document represents the number of known male visitors divided by the number of known female visitors over a particular period of time. If the value of the average-gender-ratio variable across the number of documents visited by the unknown user is greater than 1, then, on average, the documents visited by the user are more frequently visited by males and the software predicts the user's gender to be male (especially if the average-gender-ratio is significantly greater than 1). If the value of the average-gender-ratio variable across the number of documents visited by the unknown user is less than 1, then, on average, the documents visited by the user are more frequently visited by females and the software predicts the user's gender to be female (especially if the average gender-ratio is significantly less than 1). In one embodiment, a gender-correlation factor may be computed for the unknown user, wherein the gender-correlation factor reflects a higher correlation with a male prediction of gender depending upon how much larger than 1 the average-gender-ratio was as computed, and wherein the gender-correlation factor reflects a higher correlation with a female gender prediction depending upon how much lower than 1 average gender-ratio was as computed.

In another embodiment, the a user's gender can be predicted based upon the gender-usage data stored for documents that the user visits or has visited in the recent past using a percentage approach. For example, a user of unknown gender visits a number of documents, each of which is associated with gender-usage data including a percent-male value for each. A value of an “average-percent-male” variable is then computed across the number of documents that the user visited, wherein the average-percent-male variable represents the statistical average of the values of the percent-male variables associated with each of the number of documents visited, wherein the value of the percent-male variable of each document represents the percentage of known visitors who were identified as male. If the value of the average-percent-male variable across the number of documents visited by the unknown user is greater than 50%, then, on average, the documents visited by the user are more frequently visited by males and the software predicts the user's gender to be male (especially if the value of the average-percent-male variable is significantly greater than 50%—e.g., greater than 70%). If the value of the average-percent-male variable across the number of documents visited by the unknown user is less than 50%, then, on average, the documents visited by the user are more frequently visited by females and the software predicts the user's gender to be female (especially if the value of the average-percent-male variable is significantly less than 50%—e.g., less than 30%). In one embodiment, a gender-correlation factor may be computed for the unknown user, wherein the gender-correlation factor reflects a higher correlation with a male prediction of gender depending upon how much larger than 50% the value of the average-percent-male variable was as computed, and wherein the gender-correlation factor reflects a higher correlation with a female gender prediction depending upon how much lower than 50% the value of the average-percent-male variable was as computed.

In one embodiment, assigned-gender-correlation data may be associated with each document visited by the user and may be used in addition to (or instead of) the gender based visit data of the documents visited by a user to predict his or her gender. For example, if the user visits a number of sites and more of those sites have an assigned-gender-correlation with male than female, the user may be predicted to be male. Depending upon the relative numbers of assigned-gender-correlations that are associated with male as opposed to female, the strength of the prediction may vary. For example, if 5 times as many documents visited by the unknown user have assigned-gender-correlations that are associated with male users, the software may strongly predict that the unknown user is male. The strong prediction may be reflected in the assignment of identified-gender data for that user that includes an indication that the user is male and includes a gender-correlation factor that is relatively high (e.g., 0.78). If, on the other hand, only 2 times as many documents visited by the unknown user have assigned-gender-correlations that are associated with male users, the software may weakly predict that the unknown user is male. The weaker prediction may be reflected in the assignment of identified-gender data for that user that includes an indication that the user is male and includes a gender-correlation factor that is relatively low (e.g., 0.35).

In one embodiment, the predicted gender of a user (determined, for example, based upon a correlation between the documents visited by that user and the gender-usage data associated with those visited documents) may be used as an identified gender for that user when a search query is received by that user and documents are to be ordered. Thus, the aforementioned methods for ordering documents based upon an identified gender for a user who performs a search query may be employed using a predicted gender for the user who performs the search.

In one embodiment, the predicted gender of a user (determined, for example, based upon a correlation between the documents visited by that user and the gender-usage data associated with those visited documents) may be used in other processes. For example, the predicted gender of a user may be used in matching relevant advertisements to the user as the user visits particular web sites. In one exemplary implementation, advertisements may be served to the user that are better adapted to male users if the predicted gender of that user was determined to be male. Similarly, advertisements may be served to that user that are better adapted to female users if the predicted gender of that user was determine to be female.

In one embodiment, the aforementioned methods for predicting the gender of a user of an unknown gender may be similarly adapted to predict the age group of a user of an unknown age. Accordingly, one embodiment provides a computational infrastructure within which the age of a user of unknown age can be accurately predicted based upon previously collected age-usage data from other users and data reflecting the current and/or historical document visiting habits of the current user of unknown age. The predicted age may then be assigned to the user of unknown age as the identified-age of the user.

As mentioned above, the age of a user of unknown age can be predicted by correlating the documents that he or she is currently visiting and/or has historically visited with the age-usage data for those documents. For example, if a user has recently visited ten web site documents, each of those documents having age-usage data showing the strongest relative correlation with an identified age group of 19 to 25 years old, the software is adapted to predict that the current user of unknown age is in the group between 19 and 25 years old. Furthermore, the software can assign an identified age-group to that unknown user of 19 to 25 years old. Because the gender was predicted and not provided by the user directly, the software can set an age-correlation factor for that user to a low value. As the user visits additional sites having age-usage data that are strongly correlated to the age group 19 to 25 years old, the software routines may increase the age-correlation factor for the user. In this way, the age grouping of a user may be predicted based upon the age-usage data stored for sites and/or documents that the user visits if that data reflects a stronger correlation with some age groups over others. In addition, the software routines may assign and/or adjust an age-correlation factor based upon the degree of correlation of the age-usage data for web sites and/or documents that the user visits over a period of time with the predicted age group of the user.

Thus, the software may predict the age of a user of unknown age based upon the age-usage data stored for documents that the user visits or has visited in the recent past and assign the predicted age to the user as the identified-age of the user. In one example, a user of unknown age visits a number of documents, each of which is associated with age-usage data including a value of a “percent-19-to-25-years-old” variable. A mean or average value of the “percent-19-to-25-years-old” variable (i.e., an “average-percent-19-to-25-years-old” variable) may be computed across the number of documents that the user visited along with averages for other age groups. If the average-percent-19-to-25-years-old variable is substantially larger than the averages computed for other age groups, then, on average, the documents visited by the user are more frequently visited by users who are between 19 and 25 years of age and the software predicts the user's age group to be 19 to 25 years old. The larger the value of the average-percent-19-to-25-years-old variable as compared to other age groups, the stronger the prediction that can be made. In one embodiment, an age-correlation-factor may be computed for the unknown user, the age-correlation factor reflecting the strength of the prediction made.

In one embodiment, assigned-age-correlation data may be associated with each document visited by the user and may be used in addition (or instead of) to the age group based visit data of the documents visited by a user to predict his or her age group.

In one embodiment, the predicted age group of a user (determined, for example, based upon a correlation between the documents visited by that user and the age-usage data associated with those visited documents) may be used as an identified age group for that user when a search query is received by that user and documents are to be ordered. Thus, the aforementioned methods for ordering documents based upon an identified age group for a user who performs a search query may be employed using a predicted age group for the user who performs the search.

In one embodiment, the predicted age group of a user (determined, for example, based upon a correlation between the documents visited by that user and the age-usage data associated with those visited documents) may be used in other processes. For example, the predicted age group may be used in matching relevant advertisements to the user as the user visits particular web sites. In one exemplary implementation, advertisements may be served to the user that are better adapted to users of an age group (e.g., below 8 years old) that matches the predicted age group of that user. Accordingly, advertisements may be served to the user that are better adapted to users who fall within the below 8 years old age group as compared to other age groups.

Using the methods exemplarily described herein, the gender and/or age group of a user may be predicted based upon the documents that a user visits in combination with additional data such as age-usage data and/or gender-usage data for those documents. The predicted gender and/or age group may be used by the methods exemplarily described herein to better order documents retrieved in response to a search query entered by the user. The predicted gender and/or age group may also be used to select an advertisement from a plurality of available advertisements (for example on a server), the selected advertisement being relationally associated with the predicted gender and/or age group (for example on the server).

In some cases, identified-gender data for a user may not be well correlated with the predicted document preferences of the user. This may be because the user lied about their gender when entering the data. This may also be because not all users behave as predicted by their biological gender. In fact, some users may behave in ways that are more closely correlated with the opposite gender to their biological gender. Because the gender related document preferences are derived based upon statistical trends and averages, it will be statistically rare for users to behave significantly outside their biological gender, but still it may be desirable to account for such situations in the methods described herein. To account for such situations, one embodiment provides a method of determining how well a users document visiting habits correlate with his or her identified gender and, in response to a negative correlation, adjust the identified gender to match the behavior rather than the data entered by the user. The methods of determining how well a user's document visiting habits correlate with his or her identified gender may be essentially the same as the methods described above for predicting the gender of a user having an unknown gender. Accordingly, the software may determine how well the user's visiting behavior correlate with other users of his or her identified gender based upon the documents that a user visits in combination with gender-usage data for those documents (and/or assigned-gender-correlation data for those documents). If the correlation is strongly negative, the user's identified gender may be changed by the methods described herein. Such a changed identified gender may be referred to as a “behaviorally-derived-identified-gender” because it was derived based upon the user's document viewing behavior rather than his or her biological gender (or user claimed biological gender). The behaviorally-derived-identified-gender may be used in the same way as a predicted gender described above to better order documents retrieved in response to a search query entered by the user and/or to select an advertisement from a plurality of available advertisements (e.g., on a server), wherein the selected advertisement is relationally associated with the behaviorally-derived-identified-gender.

In some cases, identified-age data for a user may not be well correlated with the predicted document preferences of the user. This may be because the user lied about their age when entering the data. This may also be because not all users behave as predicted by their biological age. In fact, some users may behave in ways that are more closely correlated with older age groups. Other users may behave in ways that are more closely correlated with younger age groups. Because the age-group related document preferences are derived based upon statistical trends and averages, it will be statistically rare for users to behave significantly outside their age group, but still it may be desirable to account for such situations in the methods described herein. To account for such situations, one embodiment provides a method of determining how well a users document visiting habits correlate with his or her identified-age-group and, in response, to a stronger correlation with an alternate age group, adjust the identified-age data to match the document viewing behavior rather than the data entered by the user. The methods of determining how well a user's document visiting habits correlate with his or her identified-age-group may be essentially the same as the methods described above for predicting the age group of a user having an unknown age. Accordingly, the software may determine how well the user's document visiting behavior correlates with other users of his or her identified age group based upon the documents that a user visits in combination with age-usage data for those documents (and/or assigned-age-correlation data for those documents). If the correlation is more strongly matched to an alternate age group, the user's identified age group may be changed to that alternate age group. Such a changed identified age group may be referred to as a “behaviorally-derived-identified-age-group” because it was derived based upon the user's document viewing behavior rather than his or her biological age (or user claimed biological age). The-behaviorally-derived-identified-age-group may be used in the same way as a predicted age group described above to better order documents retrieved in response to a search query entered by the user and/or to select an advertisement from a plurality of available advertisements (for example on a server), wherein the selected advertisement is relationally associated with the behaviorally-derived-identified-age-group.

While the invention herein disclosed has been described by means of specific embodiments, examples and applications thereof, numerous modifications and variations could be made thereto by those skilled in the art without departing from the scope of the invention set forth in the claims.

What is claimed is:

1. A computer implemented method of organizing a set of documents, comprising:
receiving a search query from a user;
obtaining identified-age data for the user, the identified-age data including information describing an age of the user;
identifying a set of documents responsive to the search query;
assigning a score to each identified document based upon a correlation between age-usage data for each document and identified-age data, the age-usage data describing at least one of a number and frequency of users who have previously accessed the document who are of a particular age or age range; and
organizing the documents based at least in part on the assigned score.

2. The computer implemented method of claim 1, wherein obtaining the identified-age data comprises receiving a query response from the user.

3. The computer implemented method of claim 1, wherein obtaining the identified-age data comprises accessing the identified-age data from a data store on a computer.

4. The computer implemented method of claim 1, wherein the age-usage data describes a number of users of the particular age or age range who accessed the document during a predetermined period of time.

5. The computer implemented method of claim 1, wherein the age-usage data describes a frequency with which users of the particular age or age range accessed the document during a predetermined period of time.

6. The computer implemented method of claim 1, wherein obtaining the identified-age data comprises deriving identified-age data based on the user's document viewing behavior.

7. The computer implemented method of claim 1, further comprising adjusting the obtained identified-age data based on the user's document viewing behavior.

8. The computer implemented method of claim 1, wherein the identified-age data describes one of an annual age of the user and a range of annual ages within which the annual age of the user falls.

9. The computer implemented method of claim 1, wherein
the identified-age data further includes an age-correlation factor of the user, the age-correlation factor indicating a degree of statistical relevance that age has for predicting a document preference for the user; and
assigning a score to each identified document further comprises assigning a score based upon the age-correlation factor.

10. The computer implemented method of claim 9, further comprising adjusting the age-correlation factor based on the user's document viewing behavior.

11. The computer implemented method of claim 1, further comprising:
obtaining identified-gender data for the user, the identified-gender data including information describing a gender of the user, wherein
assigning a score to each identified document further comprises assigning a score based upon a correlation between gender-usage data for each document and identified-gender data, the gender-usage data describing at least one of a number and frequency of users who have previously accessed the document who are of a particular gender.

12. The computer implemented method of claim 11, wherein obtaining the identified-gender data comprises receiving a query response from the user.

13. The computer implemented method of claim 11, wherein obtaining the identified-gender data comprises accessing the identified-gender data from a data store on a computer.

14. The computer implemented method of claim 11, wherein obtaining the identified-gender data comprises deriving identified-gender data based on the user's document viewing behavior.

15. The computer implemented method of claim 11, further comprising adjusting the obtained identified-gender data based on the user's document viewing behavior.

16. The computer implemented method of claim 11, wherein
the identified-gender data further includes a gender-correlation factor of the user, the gender-correlation factor indicating a degree of statistical relevance that gender has for predicting a document preference for the user; and
assigning a score to each identified document further comprises assigning a score based upon the gender-correlation factor.

17. The computer implemented method of claim 16, further comprising adjusting the gender-correlation factor based on the user's document viewing behavior.

18. The computer implemented method of claim 1, further comprising:
correlating the age-usage data for each document with rating data for that document, the rating data indicating a level of usefulness of the identified document to one or more previous users who accessed the document and who are of the particular age or age range, wherein
assigning a score to each identified document further comprises assigning a score to each identified document based upon the correlation between the rating data for each document and the identified-age data.

19. The computer implemented method of claim 18, further comprising receiving rating data from the user.

20. The computer implemented method of claim 18, further comprising deriving rating data from the user's actions.

21. A computer implemented method of organizing a set of documents, comprising:
receiving a search query from a user;
obtaining identified-gender data for the user, the identified-gender data including information describing a gender of the user;
identifying a set of documents responsive to the search query;
assigning a score to each identified document based upon a correlation between gender-usage data for each document and identified-gender data, the gender-usage data describing at least one of a number and frequency of users who have previously accessed the document who are of a particular gender; and
organizing the documents based at least in part on the assigned score.

22. The computer implemented method of claim 21, wherein obtaining the identified-gender data comprises receiving a query response from the user.

23. The computer implemented method of claim 21, wherein obtaining the identified-gender data comprises accessing the identified-gender data from a data store on a computer.

24. The computer implemented method of claim 21, wherein obtaining the identified-gender data comprises deriving identified-gender data based on the user's document viewing behavior.

25. The computer implemented method of claim 21, further comprising adjusting the obtained identified-gender data based on the user's document viewing behavior.

26. The computer implemented method of claim 21, wherein the gender-usage data describes a number of users of the particular gender who accessed the document during a predetermined period of time.

27. The computer implemented method of claim 21, wherein the age-usage data describes a frequency with which users of the particular gender accessed the document during a predetermined period of time.

28. The computer implemented method of claim 21, wherein
the identified-gender data further includes a gender-correlation factor of the user, the gender-correlation factor indicating a degree of statistical relevance that gender has for predicting a document preference for the user; and
assigning a score to each identified document further comprises assigning a score based upon the gender-correlation factor.

29. The computer implemented method of claim 28, further comprising adjusting the gender-correlation factor based on the user's document viewing behavior.

30. The computer implemented method of claim 21, further comprising:
correlating the age-usage data for each document with rating data for that document, the rating data indicating a level of usefulness of the identified document to one or more previous users who accessed the document and who are of the particular gender, wherein
assigning a score to each identified document further comprises assigning a score to each identified document based upon the correlation between the rating data for each document and the identified-gender data.

31. The computer implemented method of claim 30, further comprising receiving rating data from the user.

32. The computer implemented method of claim 30, further comprising deriving rating data from the user's actions.

33. An apparatus for organizing a collection of documents, comprising:
circuitry having executable program instructions; and
at least one processor configured to execute the program instructions to perform operations of:
receiving a search query from a user;
obtaining identified-age data for the user, the identified-age data including information describing an age of the user;
identifying a set of documents responsive to the search query;
assigning a score to each identified document based upon a correlation between age-usage data for each document and identified-age data, the age-usage data describing at least one of a number and frequency of users who have previously accessed the document who are of a particular age or age range; and
organizing the documents based at least in part on the assigned score.

34. An apparatus for organizing a collection of documents, comprising:
circuitry having executable instructions; and
at least one processor configured to execute the program instructions to perform operations of:
receiving a search query from a user;
obtaining identified-gender data for the user, the identified-gender data including information describing a gender of the user;
identifying a set of documents responsive to the search query;
assigning a score to each identified document based upon a correlation between gender-usage data for each document and identified-gender data, the gender-usage data describing at least one of a number and frequency of users who have previously accessed the document who are of a particular gender; and
organizing the documents based at least in part on the assigned score.

35. An apparatus for organizing a collection of documents, comprising:
circuitry having executable instructions; and
at least one processor configured to execute the program instructions to perform operations of:
receiving a search query from a user;
obtaining identified-age data for the user, the identified-age data including information describing an age of the user;
obtaining identified-gender data for the user, the identified-gender data including information describing a gender of the user;
identifying a set of documents responsive to the search query;
assigning a score to each identified document based upon a correlation between age-usage data for each document and identified-age data and based upon a correlation between gender-usage data for each document and identified-gender data, the age-usage data describing at least one of a number and frequency of users who have previously accessed the document who are of a particular age or age range and the gender-usage data describing at least one of a number and frequency of users who have previously accessed the document who are of a particular gender; and
organizing the documents based at least in part on the assigned score.
